(19) United States
(12) Patent Application Publication
(10) Pub. No.: US 2015/0273586 A1
(43) Pub. Date: Oct. 1, 2015

(54) Additive Manufacturing Process for Tubular with Embedded Electrical Conductors

(71) Applicant: Baker Hughes Incorporated, Houston, TX (US)

(72) Inventor: Colby W. Ross, Hockley, TX (US)

(73) Assignee: Baker Hughes Incorporated, Houston, TX (US)

(21) Appl. No.: 14/229,066

(22) Filed: Mar. 28, 2014

(51) Int. Cl. B22F 7/08; E21B 17/042; B23K 15/00; B22F 5/10; B22F 7/06; B23K 26/34; E21B 17/00; B22F 3/105

(52) U.S. Cl. CPC B22F 7/08; E21B 17/003; E21B 17/042; B22F 3/1055; B22F 5/106; B22F 7/062; B23K 26/345; B23K 15/0086; B33Y 10/00

(57) ABSTRACT

A method of forming a tubular by additive manufacturing, where the method includes forming passages in a sidewall of the tubular and conductive elements in the passages as the tubular is being formed. Additional tubulars can be formed, so that when the tubulars are connected together the conductive elements in each tubular are in signal communication with one another. Adding threads to each tubular enables the tubulars to be coupled together to form a string. Conductive rings simultaneously formed in the ends of the tubulars provides contact means between adjacent tubulars in the string.

### BACKGROUND OF THE INVENTION

1. Field of Invention

The present disclosure relates in general to a method of using additive manufacturing to form a tubular having integrally formed signal lines and connectors.

2. Description of Prior Art

Tubulars are typically used in many facets of the production of hydrocarbons from subterranean formations. Drill strings, which are used to form the wellbores that intersect the formations, are often made up of a number of individual tubular joints threaded together end to end, and a drill bit connected to the lower end of the lowermost tubular joint. A completed wellbore is usually fitted with a tubular string of casing that is cemented to the wall of the wellbore. The cement is for well control by preventing hydrocarbons from flowing between the casing and wellbore wall. Other tubulars generally used for hydrocarbon production include production tubing, which is usually inserted into the casing and through which hydrocarbons from the formation flow to the surface. Coiled tubing, which is another hydrocarbon production tubular, is typically used to deploy downhole tools, such as perforating systems, within a wellbore. Sometimes the tubulars include axial passages within their sidewalls designed for data or other signal transmitting lines.

### SUMMARY OF THE INVENTION

Provided herein is a method of forming a tubular for use in a wellbore, that in one embodiment includes depositing successive layers of a tubular body base material and directing energy at the layers of tubular body base material to form a tubular body, forming axial passages in a sidewall of the tubular by strategically depositing the successive layers of the base material, and forming conductive elongate members in the passages by depositing successive layers of conductive elongate member base material for forming the conductive elongate members, and directing energy at the layers of conductive elongate member base material. The conductive elongate members may include a conductive core and an insulating material on an outer surface of the conductive core. The method may further include forming a curved passage in the sidewall of the tubular that is oriented along a path that circumscribes an axis of the tubular. This example can further include forming a conductive ring in the curved passage, and conductively coupling the conductive ring to an end of one of the conductive elongate members. Threads may optionally be formed on the tubular body by strategically depositing the layers of tubular body material. Threads may alternatively be machined strategically to expose a conductive element. The threads may be male threads and female threads. In one embodiment, the tubular body is a first tubular body, the method further includes repeating the above steps to form a second tubular body, forming threads on the first and second bodies, and threadingly coupling the first and second tubular bodies. Conductive elongate members in the first tubular body can be put into communication with the conductive elongate members in the second tubular body when the first and second tubular bodies are threaded together. Optional insulator members can be included for isolating the tubular body and conductive elements.

Another example method of forming a tubular for use in a wellbore involves forming tubular bodies by depositing successive layers of a tubular body base material and directing energy at the layers of tubular body base material to form a tubular body, depositing additional successive layers of a tubular body base material and directing energy at the additional successive layers of tubular body base material to form an additional tubular body, forming axial passages in sidewalls of the tubular bodies by strategically depositing the successive layers of the base material, forming conductive elongate members in the passages by depositing successive layers of conductive elongate member base material for forming the conductive elongate members, and directing energy at the layers of conductive elongate member base material, and coupling together the tubular body and the additional tubular body so that the conductive elongate members in the tubular body are in communication with the conductive elongate members in the additional tubular body. The method can further include providing a signal in a conductive elongate member in the tubular body that is transmitted to a corresponding conductive elongate member in the additional tubular body. In an example, the signal is initiated in a wellbore, the method further comprising transmitting the signal to a controller on surface and above the wellbore. Alternatively, the tubular body and additional tubular body is a tubular member, such as wellbore casing, production tubing, drill string, coiled tubing, or combinations thereof. Curved passages may optionally be formed in the sidewall of the tubulars that circumscribe an axis of the tubulars and adding connector rings in the curved passages. The method may further include forming insulation on an outer surface of the conductive elongate member.

### BRIEF DESCRIPTION OF DRAWINGS

Some of the features and benefits of the present invention having been stated, others will become apparent as the description proceeds when taken in conjunction with the accompanying drawings, in which:

FIG. 1 is a schematic illustration in perspective view depicting an example of using additive manufacturing to form a tubular having transmission lines in accordance with the present disclosure.

FIG. 2 is a side sectional view of an example of tubulars formed using the example of FIG. 1 and in accordance with the present disclosure.

FIG. 3 is an axial sectional view of an example of an electrically conductive assembly in accordance with the present disclosure.

FIG. 4 is a side partially sectional view of an example of the tubular of FIG. 1 disposed in a wellbore and in accordance with the present disclosure.

While the invention will be described in connection with the preferred embodiments, it will be understood that it is not intended to limit the invention to that embodiment. On the contrary, it is intended to cover all alternatives, modifications, and equivalents, as may be included within the spirit and scope of the invention as defined by the appended claims.

### DETAILED DESCRIPTION OF INVENTION

The method and system of the present disclosure will now be described more fully hereinafter with reference to the accompanying drawings in which embodiments are shown. The method and system of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout. In an embodiment, usage of the term about includes +/−5% of the cited magnitude, and usage of the term substantially includes +/−5% of the cited magnitude.

It is to be further understood that the scope of the present disclosure is not limited to the exact details of construction, operation, exact materials, or embodiments shown and described, as modifications and equivalents will be apparent to one skilled in the art. In the drawings and specification, there have been disclosed illustrative embodiments and, although specific terms are employed, they are used in a generic and descriptive sense only and not for the purpose of limitation.

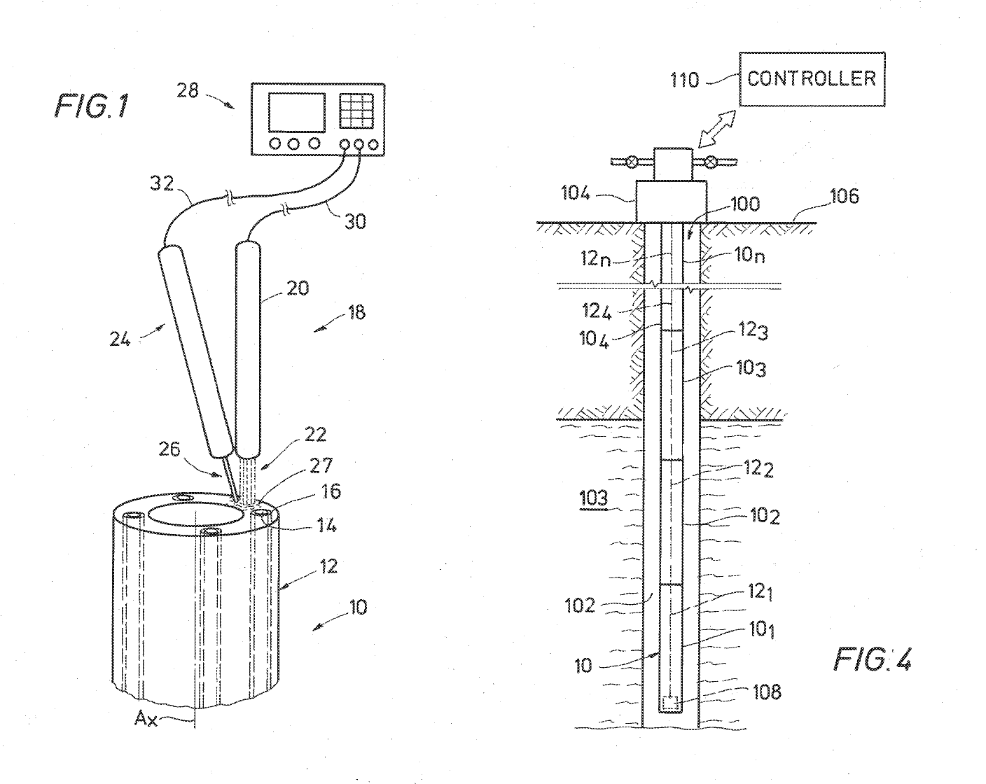

FIG. 1 shows in a side perspective view one example of forming a tubular 10 using an additive manufacturing process. As the tubular 10 is being formed, so are electrically conductive assemblies 12 being formed integrally disposed within the tubular 10. The conductive assemblies 12 each include an elongate conductive element 14, which is electrically conductive and capable of transmitting electricity as well as signals for transmitting data. Example signals include analog, digital, radio, and any other signal capable of transmitting information. Electrically conductive assemblies 12 as shown disposed in passages 16, which are also being integrally formed within the tubular 10 during formation of the tubular 10. In the example of FIG. 1, passages 16 are generally axial and substantially parallel within Axis A_{X} of tubular 10.

An example manufacturing system 18 is shown that is used for forming the tubular 10, and which includes a material deposition system 20 that strategically deposits successive layers of powdered material 22. By applying energy, in the form of light or heat, to the layers of powdered material 22, the powdered material 22 becomes coherent and forms the solid tubular 10; include the passages 16 and electrically conductive assemblies 12. In the example of FIG. 1, the energy is supplied in the form of a laser 24 shown directing a laser beam 26 to a layer 27 of powdered material 22 shown having been deposited onto the upper most portion of the tubular 10. An optional controller 28 may be coupled with both the deposition system 20 and laser 24 for controlling operation and for orientation of both the deposition system 22 and laser 24. Leads 30, 32 respectively connect the material deposition system 20 and laser 22 to controller 28. Thus, strategic operation and orientation of the material deposition system forms the passages 16 within the tubular 10 as the tubular 10 is being formed. Moreover, strategic substitution of different types of material making up the powdered material 22 enables the electrically conductive assembly 12 to have a different material composition from tubular 10. Alternatively, an additional or different material deposition system (not shown) may be employed for forming the different material compositions.

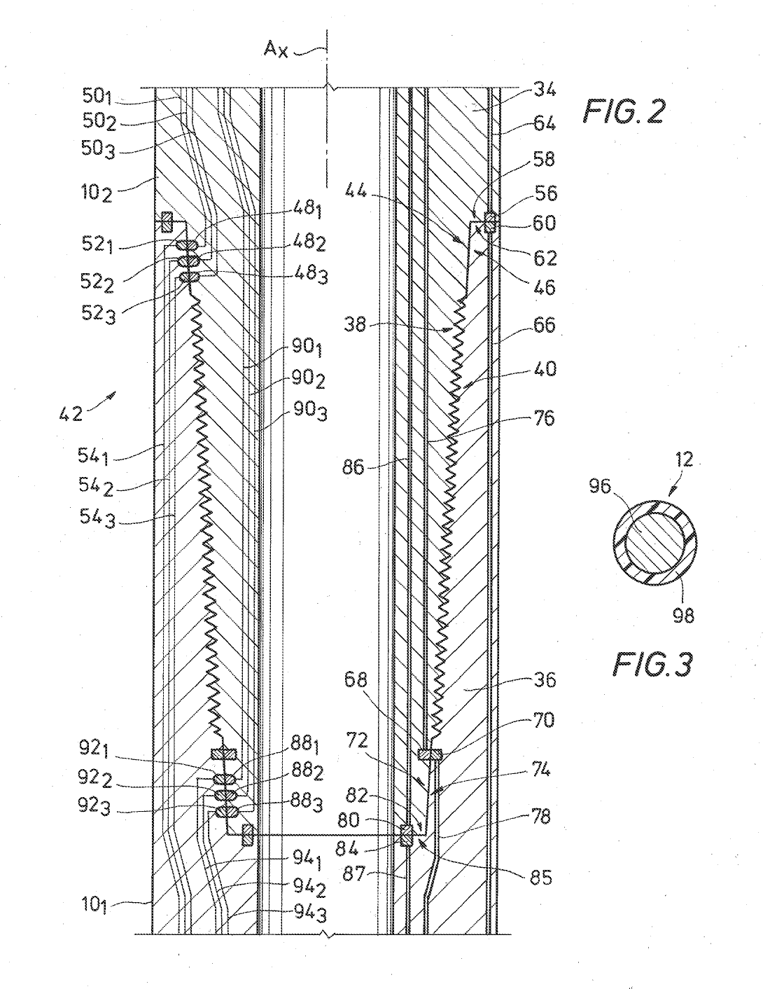

FIG. 2 is a side sectional view of an example of first and second tubulars 10₁, 10₂ threadingly coupled to one another. In this example, each of the tubulars 10₁, 10₂ were formed using an additive manufacturing process (such as the one explained above and illustrated in FIG. 1) or other similar method. Examples of alternative formation processes include rapid manufacturing, selective heat sintering, selective laser sintering, selective laser melting, direct metal laser sintering, electron beam melting, and combinations thereof. As shown in FIG. 2, the end of the tubular 10₂ shown defines a pin member 34 which threadingly inserts into a box end 36 of tubular 10₁. Threads 38 formed on the outer surface of pin member 34 are shown engaged with threads 40 correspondingly formed on the inner surface of box member 36. The engagement of the threads 38, 40 on pin and box members 34, 36 define a threaded connection.

An oblique shoulder 44 is shown on an outer surface of the pin member 34 and adjacent an end of the threads 38 distal from the terminal end of pin member 34. A corresponding oblique member 46 is on an inner surface of the box member 36 and shown circumscribing oblique shoulder 44. Oblique shoulders 44, 46 are oriented in complimentary angles and generally in contact along their respective lengths. A series of contacts 48₁-48₃ are shown formed along oblique shoulder 44 within pin member 34. Contacts 48₁-48₃ respectively connect to electrically conductive assemblies 50₁-50₃ shown formed in passages formed through the pin member 34. Similarly, contacts 52₁-52₃ are shown formed within box member 36 and along oblique shoulder 46. Strategic placement of contacts 48₁-48₃ and contacts 52₁-52₃ provide an electrical connection between contacts 48₁-48₃ and contacts 52₁-52₃. As such, electrically conductive assemblies 50₁-50₃ are in electrical communication with electrically conductive assemblies 54₁-54₃ shown formed in passages that extend through the box member 36. In the example of FIG. 2, contacts 48₁-48₃ and contacts 52₁-52₃ are at designated angular locations along the outer circumference of the shoulders 44, 46. However, examples exist where contacts 48₁-48₃ and contacts 52₁-52₃ are ring like members that circumscribe the entire circumference of the shoulders 44, 46.

An annular ring contact 56 is shown formed within a passage that circumscribes axis A_{X} and is adjacent a radial shoulder 58. Radial shoulder 58 is formed where the outer surface of pin member 34 extends radially outward from oblique shoulder 44 into the outer surface of pin member 34. Corresponding ring contact 60, which is also an annular member and made from a conductive material, is shown within a passage that circumscribes axis A_{X} and is within a terminal end of box member 36 adjacent a radial shoulder 62. Radial shoulder 62 is generally perpendicular to axis A_{X}, and extends between oblique shoulder 46 and an outer surface of pin member 36. An axially extending passage that terminates at ring contact 56 houses signal line 64 which is shown electrically coupled with ring contact 56. Corresponding signal line 66 is shown extending axially through box member 36 and within a passage in having an end electrically in contact with ring contact 60. Therefore, when the threaded connection 42 is formed electrical communication is provided between signal lines 64, 66.

Additional ring contacts 68, 70 are shown formed respectively along oblique shoulders 72, 74 that are at ends of the threads 38, 40 opposite from oblique shoulders 44, 46. Ring contacts 68, 70 are set radially inward from ring contacts 56, 60. Signal line 76 is shown within a passage that extends axially through pin member 34 and radially inward from signal line 64. A terminal end of signal line 76 connects to ring contact 68. Further shown in FIG. 2 is signal line 78 shown having a terminal end connected to ring contact 70, signal line 78 extends through an axial passage formed axially through pin member 36. Accordingly, when the threaded connection 42 is formed, electrical communication is provided between signal lines 76, 78 via the electrical and signal communication between ring contacts 68, 70. Moreover, as ring contacts 68, 70 are annular members and circumscribe axis A_{X}, electrical contact and communication can take place between signal lines 76, 78 irrespective of the angular orientation of the pin and box members 34, 36, as long as the axial orientation puts the ring contact 68, 70 in contact or adjacent one another.

Ring contact 80 is shown on a side of ring contact 68 distal from threads 40 and adjacent a terminal end of box member 34. Ring contact 80 is adjacent a radial shoulder 82 formed where the outer surface of pin member 34 extends radially between its inner annulus and the oblique shoulder 72. A ring contact 84 is shown formed in box member 36 and in communication with ring contact 80. Ring contact 84 is adjacent a radial shoulder 85 that is formed where the outer surface of box member 36 extends between its inner radial wall and oblique shoulder 78. Signal line 86 is shown formed axially through pin member 34 in a passage and has an end that connects to ring contact 80. A axial passage within pin member 36 terminates at ring contact 84 and houses a signal line 87 shown having an end connecting to ring contact 84. Thus, when the threaded connection 42 is formed electrical communication is provided between lines 86, 87.

Also formed along oblique shoulder 72 and within pin member 34 are contacts 88₁-88₃. Passages extends through the pin member 34 that hold electrically conductive assemblies 90₁-90₃, electrically conductive assemblies 90₁-90₃ respectively connect to and are in communication with contacts 88₁-88₃. Contacts 92₁-92₃ are shown in the box member 36 and along oblique shoulder 74 that are respectively in communication with contacts 88₁-88₃. Passages formed within box member 36 house electrically conductive assemblies 94₁-94₃, conductive assemblies 94₁-94₃ connect respectively to contacts 92₁-92₃. Similarly, when the threaded connection 42 is formed electrical and signal communication is provided between the electrically conducted assemblies 90₁-90₃ and electrically conductive assemblies 94₁-94₃ via contacts 88₁-88₃ and contacts 92₁-92₃. It should be pointed out, that each of the components described above within the tubulars 10₁, 10₂ may be formed with the method described in FIG. 1 and other manufacturing methods described herein. In an example, the tubulars 10₁, 10₂ can be formed using an additive manufacturing method, such as the method illustrated in FIG. 1, but where the threads 38, 40 are formed by machining that then exposes any conductive leads, such as ring contacts 68, 70 and contacts 48₁-48₃, 52₁-52₃, 88₁-88₃, 92₁-92₃. Moreover, an insulating ring (not shown) can be provided around ring contacts 68, 70, 80, 84, which is formed during the forming process of the ring contacts 68, 70, 80, 84. Seals (not shown) may also optionally be included to seal around the threaded connection 42 and prevent fluid and/or pressure communication across the threaded connection 42.

FIG. 3 shows a cross sectional example of one embodiment of a conductive element 14 wherein an inner electrically conductive core 96 is housed within an insulating jacket 98. Accordingly, strategic displacement of different materials is required to form the subsequent and successive layers of the conductive element 14 so that it may be integrally formed within the tubular 10 of FIG. 1.

FIG. 4 shows one example of a tubular string 100 being inserted into a borehole 102, wherein borehole 102 intersects formation 103. In this example, the tubular string 100 is made up of a number of tubular joints 10₁-10ₙ that are axially connected together, such as the threaded connections 42 (FIG. 2). In this example, electrically conductive assemblies 12₁-12ₙ and each of the tubulars 10₁-10ₙ form a coherent unit so that a signal starting at one end of the tubular string 100 may be transmitted to its other end. Further in the example of FIG. 4, the tubular string 100 has an upper end coupled with a wellhead assembly 104. Optionally, the tubing string 100 can be string of casing for lining the wellbore 102, production tubing for carrying production fluids from within the formation 103 to surface and through the wellhead assembly 104, coiled tubing which may be used for deploying other downhole tools, or a drill string which is used for drilling a wellbore 102. The wellhead assembly 104, shown on surface 106 is distal from a sensor 108 on the tubing string 100 and disposed deep within wellbore 102. In the example, sensor 108 is in electrical communication with electrically conductive assembly 12₁, and through the electrical connections at each joint, any signals generated by sensor 108 or transmitted by sensor 108 can be transmitted to wellhead assembly 104 into a controller 110 on surface 106 and wherein communication can be between controller 110 and sensor 108 for conducting any downhole activity. It should be pointed out that other downhole devices in addition to a sensor may be included with this system and that are connected to the transmission line, such as valves, packers, and any other actuatable device or detecting device.

The present invention described herein, therefore, is well adapted to carry out the objects and attain the ends and advantages mentioned, as well as others inherent therein. While a presently preferred embodiment of the invention has been given for purposes of disclosure, numerous changes exist in the details of procedures for accomplishing the desired results. In the embodiments provided herein, the ring contacts are electrically conductive and annular, additional embodiments exist where the ring contacts may not fully circumscribe the axis A_{X}, but still come into contact with a corresponding contact via formation of the threaded connection 42. Also, the electrically conductive assemblies, signal lines, ring contacts can be formed from electrically conductive material, or may optionally be formed from a media that transmits forms of signals, such as optical signals. These and other similar modifications will readily suggest themselves to those skilled in the art, and are intended to be encompassed within the spirit of the present invention disclosed herein and the scope of the appended claims.

What is claimed is:

1. A method of forming a tubular for use in a wellbore comprising:
a. depositing successive layers of a tubular body base material and directing energy at the layers of tubular body base material to form a tubular body;
b. forming axial passages in a sidewall of the tubular by strategically depositing the successive layers of the base material; and
c. forming conductive elongate members in the passages by depositing successive layers of conductive elongate member base material for forming the conductive elongate members, and directing energy at the layers of conductive elongate member base material.

2. The method of claim 1 wherein the conductive elongate members comprise a conductive core and an insulating material on an outer surface of the conductive core.

3. The method of claim 1, further comprising forming a curved passage in the sidewall of the tubular that is oriented along a path that circumscribes an axis of the tubular.

4. The method of claim 3, further comprising forming a conductive ring in the curved passage, and conductively coupling the conductive ring to an end of one of the conductive elongate members.

5. The method of claim 1, further comprising forming threads on the tubular body by strategically depositing the layers of tubular body material.

6. The method of claim 5, wherein the threads comprise male threads and female threads.

7. The method of claim 1, wherein the tubular body comprises a first tubular body, the method further comprising repeating steps (a)-(c) to form a second tubular body, forming threads on the first and second bodies, and threadingly coupling the first and second tubular bodies.

8. The method of claim 8, wherein conductive elongate members in the first tubular body are in communication with the conductive elongate members in the second tubular body when the first and second tubular bodies are threaded together.

9. A method of forming a tubular for use in a wellbore comprising:
a. forming tubular bodies by depositing successive layers of a tubular body base material and directing energy at the layers of tubular body base material to form a tubular body;
b. repeating step (a) to form an additional tubular body;
c. forming axial passages in sidewalls of the tubular bodies by strategically depositing the successive layers of the base material;
d. forming conductive elongate members in the passages by depositing successive layers of conductive elongate member base material for forming the conductive elongate members, and directing energy at the layers of conductive elongate member base material; and
e. coupling together the tubular body and the additional tubular body so that the conductive elongate members in the tubular body are in communication with the conductive elongate members in the additional tubular body.

10. The method of claim 9, further comprising providing a signal in a conductive elongate member in the tubular body that is transmitted to a corresponding conductive elongate member in the additional tubular body.

11. The method of claim 10, wherein the signal is initiated in a wellbore, the method further comprising transmitting the signal to a controller on surface and above the wellbore.

12. The method of claim 9, wherein the tubular body and additional tubular body comprise a tubular member selected from the list consisting of wellbore casing, production tubing, drill string, coiled tubing, and combinations thereof.

13. The method of claim 9, further comprising forming curved passages in the sidewall of the tubulars that circumscribe an axis of the tubulars and adding connector rings in the curved passages.

14. The method of claim 9, further comprising forming insulation on an outer surface of the conductive elongate member.
